(19) United States
(12) Patent Application Publication
(10) Pub. No.: US 2012/0027075 A1
(43) Pub. Date: Feb. 2, 2012

(54) Signal Processing Apparatus and Signal Processing Method

(76) Inventor: Hiroyuki Kamio, Tachikawa-shi (JP)

(21) Appl. No.: 13/022,417

(22) Filed: Feb. 7, 2011

(30) Foreign Application Priority Data
Jul. 29, 2010 (JP) 2010-171135

(51) Int. Cl. H04N 11/02

(52) U.S. Cl. 375/240.01; 375/E07.026

(57) ABSTRACT

According to one embodiment, a signal processing apparatus includes a decoder, a detector, an encoder and a generator. The decoder is configured to decode a first image ssignal which is encoded by a first encoding method. The detector is configured to detect whether an image based on the first image signal is a 2D image or a 3D image. The encoder is configured to encode the first image signal into a second image signal by a second encoding method. The generator is configured to generate information to be added to the second image signal and indicating whether the image based on the second image signal is a 2D image or a 3D image, based on detection by the detector.

### CROSS-REFERENCE TO RELATED APPLICATIONS

This application is based upon and claims the benefit of priority from Japanese Patent Application No. 2010-171135, filed Jul. 29, 2010; the entire contents of which are incorporated herein by reference.

### FIELD

Embodiments described herein relate generally to a signal processing technique which adaptively processes an image signal.

### BACKGROUND

In recent years, display of 3D (3-dimensional) images is required. In BS digital broadcasting, providing 3D broadcasting is about to start. On the other hand, in CS broadcasting, providing 3D broadcasting with image signals of MPEG-4 AVC (H.264 Video) has started. Therefore, it is considered that television receivers and image recording and playback apparatuses which are compliant with 3D images will be widespread in the future.

MPEG-4 AVC image signals include information which indicates whether an image based on the image signal is a 2D image or a 3D image (hereinafter referred to as “2D/3D identification information”). Therefore, when a television receiver receives an MPEG-4 AVC signal, the television receiver can automatically switch the display method of an image based on the image signal, according to whether the image is a 2D image or a 3D image, and display the image on a monitor.

However, image signals of MPEG-2 Video do not include 2D/3D identification information. Therefore, it is necessary for the user to manually switch the image display method to 3D after 3D broadcasting is started, and switch the image display method to 2D when the broadcasting returns to 2D broadcasting. To solve such inconvenience, a method of adding 2D/3D identification information to MPEG-2 Video image signals is considered.

On the other hand, in prior art, an increasing number of home image recording and playback apparatuses (such as HDD (Hard Disk Drive) recorders) have adopted a method of converting and compressing digital broadcasting (MPEG-2 Video) image signals having large data quantity into H.264 Video image signals, and recording the signals on an HDD. Therefore, the image recording and playback apparatuses are equipped with a transcoder which converts image signals into highly-compressed image signals like this.

However, when an H.264 Video image signal obtained by converting and compressing an MPEG-2 Video image signal by the transcoder is recorded on the HDD, 2D/3D identification information disappears from the H.264 Video image signal. This is because the transcoder decodes only an image part based on the MPEG-2 Video image signal, and encodes the decoded image into an H.264 Video image. Therefore, the image recording and playback apparatus cannot determine whether the image based on the H.264 Video image signal converted by the transcoder is a 2D image or a 3D image. The same problem occurs also in the case of recording an H.264 Video image signal obtained by converting and compressing the H.264 Video signal by the transcoder on the HDD.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating a schematic configuration of an image recording and playback apparatus according to a first embodiment.

FIG. 2 is an exemplary diagram illustrating an image based on a 3D broadcasting image signal encoded by MPEG2 Video.

FIG. 3 is an exemplary diagram illustrating a data structure of a video sequence of MPEG2 Video.

FIG. 4 is an exemplary diagram illustrating a data structure in user data of MPEG2 Video.

FIG. 5 is an exemplary diagram illustrating a data structure of stereo video format signaling of MPEG2 Video.

FIG. 6 is an exemplary diagram illustrating relation between values recorded in a stereo video format signaling type and image method type.

FIG. 7 is an exemplary block diagram illustrating a structure of a transcoder according to the first embodiment.

FIG. 8 is an exemplary diagram illustrating a structure of an image stream of an H.264 Video image signal.

FIG. 9 is an exemplary block diagram illustrating a structure of a transcoder according to a second embodiment.

FIG. 10 is an exemplary block diagram illustrating a structure of a transcoder according to a third embodiment.

FIG. 11 is an exemplary block diagram illustrating a structure of a transcoder according to a fourth embodiment.

### DETAILED DESCRIPTION

Various embodiments will be described hereinafter with reference to the accompanying drawings.

In general, according to one embodiment a signal processing apparatus includes a decoder, a detector, an encoder and a generator. The decoder is configured to decode a first image signal that is encoded by a first encoding method. The detector is configured to detect whether an image based on the first image signal is a 2D image or a 3D image. The encoder is configured to encode the first image signal into a second image signal by a second encoding method. The generator is configured to generate information to be added to the second image signal and indicating whether the image based on the second image signal is a 2D image or a 3D image, based on detection by the detector.

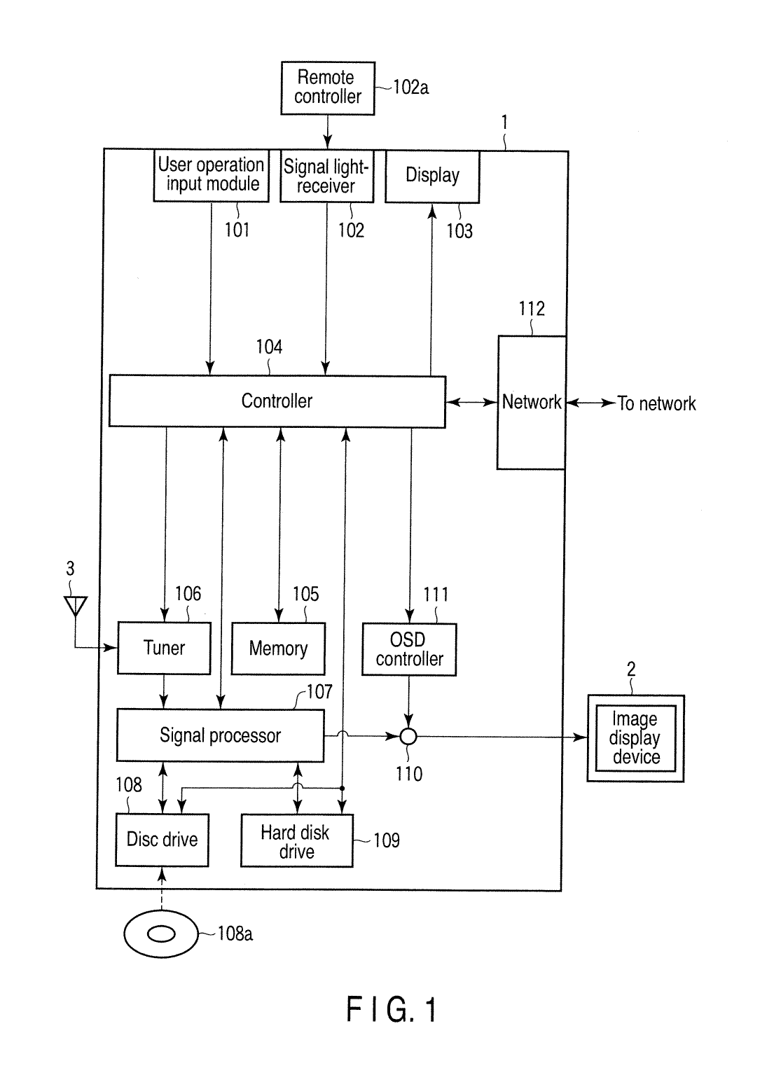

Embodiments will be described hereinafter with reference to drawings. FIG. 1 is a block diagram illustrating a schematic configuration of an image recording and playback apparatus 1 (signal processing apparatus) according to a first embodiment. The image recording and playback apparatus 1 comprises a user operation input module 101, a signal light-receiver 102, a display 103, a controller 104, a memory 105, a tuner 106, a signal processor 107, a disc drive 108, a hard disk drive 109, a combining processor 110, an OSD controller 111, and a network module 112.

The user operation input module 101 can perform user operation for the image recording and playback apparatus 1. The signal light-receiver 102 receives a signal transmitted from a remote controller 102a by user operation. The display 103 displays various messages for the user. The controller 104 controls operations of modules of the image recording and playback apparatus 1. The memory 105 stores an operation program relating to the image recording and playback apparatus 1.

The tuner 106 selects a broadcasting signal of a designated channel from reception signals received by an antenna 3. The tuner 106 outputs the selected broadcasting signal to the signal processor 107. The signal processor 107 decodes an image signal and a sound signal included in the broadcasting signal. Thereafter, when recording processing is designated, the signal processor 107 encodes the image signal and the sound signal, and outputs the image signal and the sound signal to the disc drive 108 or the hard disk drive 109. Decoding and following encoding of the image signal by the signal processor 107 will be detailed later. On the other hand, when playback processing is designated, the signal processor 107 outputs the image signal and the sound signal to the combining processor 110.

The disc drive 108 records the encoded image signal and the sound signal on an optical disc 108a. The hard disk drive 109 records the encoded image signal and the sound signal on the hard disk. The OSD controller 111 generates display information to be displayed on the screen, and outputs the display information to the combining processor 110. The combining processor 110 combines the display information with the image signal. The combining processor 110 outputs the image signal combined with the display information and the sound signal to an image display device 2. The network I/F (Interface) 112 connects the image recording and playback apparatus 1 to an external network such as the Internet, or an internal network in the building.

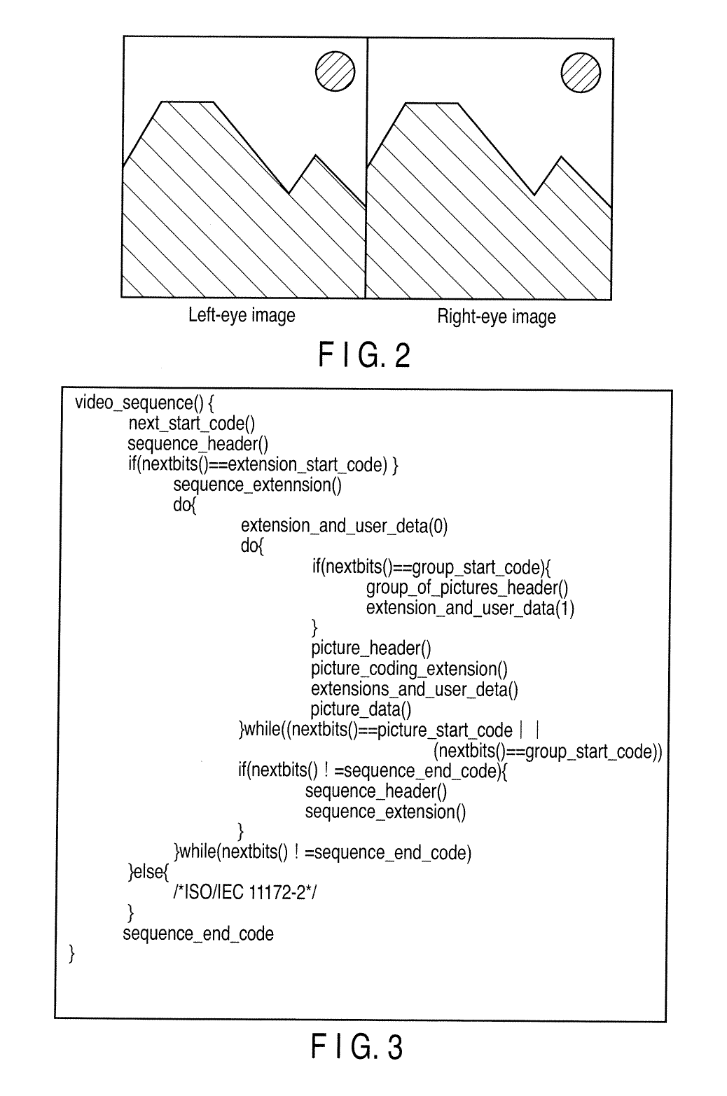

Next, a 3D broadcasting image signal encoded by MPEG2 Video will be explained hereinafter. FIG. 2 is a diagram illustrating an example of an image based on a 3D broadcasting image signal encoded by MPEG2 Video. In this example, the 3D broadcasting adopts a side-by-side method. The side-by-side method is a method of broadcasting an image signal which is formed of a left-eye image located in the left half of the image and a right-eye image located in the right half of the image. The image display device 2 which has received an image signal of the side-by-side method expands the left-eye image and the right-eye image to the size of the screen, and alternately display the images. The user can view only the left-eye image by the left eye, and only the right-eye image by the right eye, by using electronic-shutter glasses. Specifically, when the 3D broadcasting adopts the side-by side method, the image display device 2 extracts the left-eye image and the right-eye image from an image, and displays the images. Therefore, the image display device 2 can display 3D broadcasting with the existing equipment.

The method of the 3D broadcasting is not limited to the side-by-side method, as long as it can be displayed by the image display device 2 of the existing equipment. The method of the 3D broadcasting may be a line-by-line method, a top-and-bottom method, or a checker sampling method.

FIG. 3 is a diagram illustrating a data structure of a video sequence (video_sequence) defined in an MPEG2 Video signal. In a picture layer in the video sequence, user data (user_data) is defined. The user data is an area in which various information items can be defined as desired. The user data is used for, for example, definition of subtitles (closed caption).

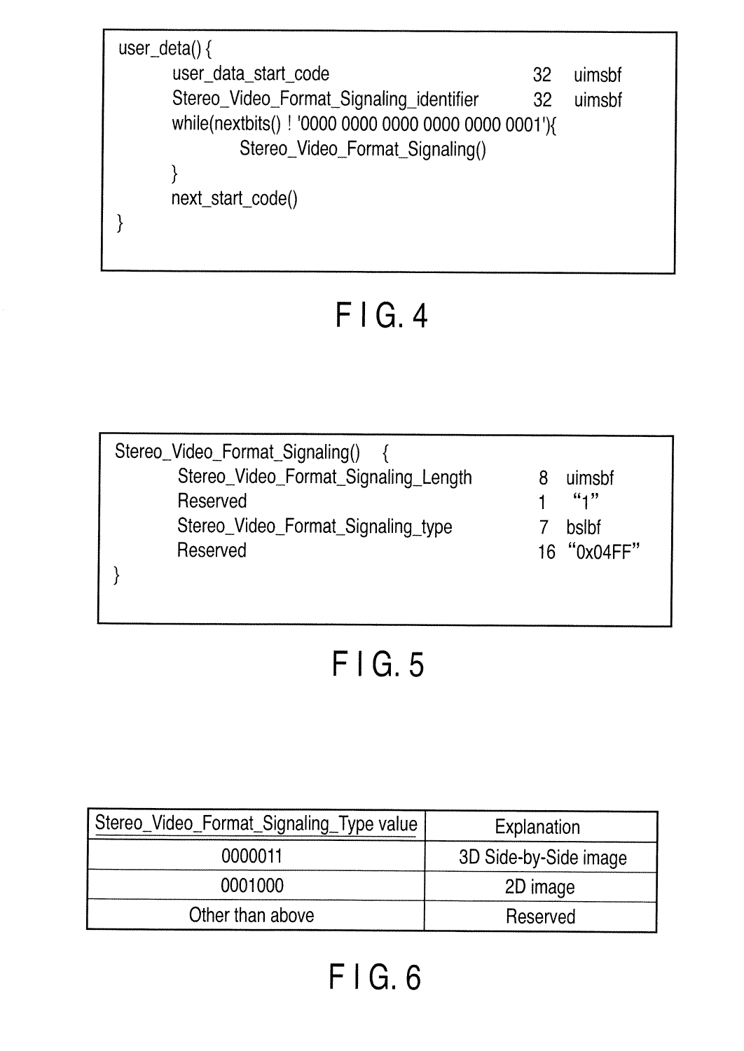

FIG. 4 is a diagram illustrating a data structure in the user data. In FIG. 4, the left lines indicate the data structure, the middle lines indicate the number of bits, and the right lines indicate the bit string. Stereo video format signaling (Stereo_Video_Format_Signaling) is defined in the user data. The stereo video format signaling is 2D/3D identification information of an image based on the image signal.

FIG. 5 is a diagram illustrating a data structure of the stereo video format signaling. In FIG. 5, the left lines indicate the data structure, the middle lines indicate the number of bits, and the right lines indicate the bit string. In the stereo video format signaling, defined are a stereo video format signaling length (Stereo_Video_Format_Signaling_length) and a stereo video format signaling type (Stereo_Video_Format_Signaling_type). The stereo video format signaling length indicates a byte length following the present field. The stereo video format signaling type indicates an image format type.

FIG. 6 is a diagram illustrating relation between the value recorded in the stereo video format signaling type and the image format type corresponding to the value. When the stereo video formatting signaling type is recorded as “0000011”, the image is a 3D image of the side-by-side method. When the stereo video format signaling type is recorded as “0001000”, the image is a 2D image. A value other than the above values may be defined for each of other 3D broadcasting methods, as the stereo video format signaling type.

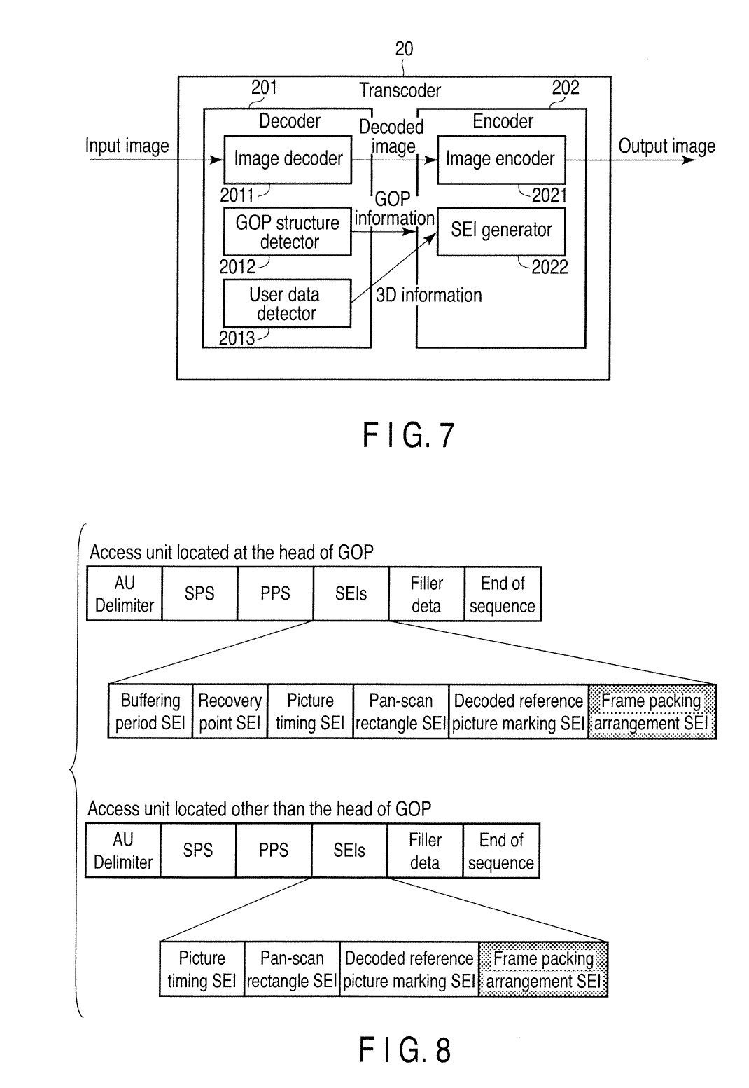

FIG. 7 is a block diagram illustrating a structure of a transcoder 20 which is included in the signal processor 107 according to the first embodiment. When recording processing is designated, the transcoder 20 decodes an image based on the image signal, and then encodes the image. The transcoder 20 includes a decoder 201, and an encoder 202. The first embodiment shows an example in which an image based on an MPEG-2 Video (first encoding method) image signal is converted into an H.264 Video image, and 2D/3D identification information included in the MPEG-2 Video image signal is also handed over to the H.264 Video (second encoding method) image signal.

The following is explanation of an H.264 Video signal. FIG. 8 is a diagram illustrating a structure of an H.264 Video image signal. The upper part of FIG. 8 illustrates an image stream of a head access unit of GOP (Group of pictures). The lower part of FIG. 8 illustrates an image stream of an access unit other than the head access unit of GOP. Each access unit includes a frame which defines each SEI (supplemental Enhancement Information). Various information items are defined in each SEI. In the H.264 image signal, an SEI frame is included in an access unit for each image. Frame packing arrangement SEI is added to the SEI frame. The frame packing arrangement SEI stores 2D/3D identification information of the image.

As illustrated in FIG. 7, the decoder 201 includes an image decoder 2011, a GOP structure detector 2012, and a user data detector 2013. The image decoder 2011 decodes an image based on the MPEG-2 Video image signal into an original image. The image decoder 2011 outputs the decoded image to the encoder 202. The GOP structure detector 2012 detects GOP structure information from the MPEG-2 Video image signal. The GOP structure detector 2012 outputs the detected GOP structure information to the encoder 202.

The user data detector 2013 monitors a user data part of the video sequence included in the MPEG-2 Video image signal. The user data detector 2013 detects whether the image is a 2D image or a 3D image, based on the stereo video format signaling of the user data. When the image is a 3D image, the user data detector 2013 outputs information based on the stereo video format signaling (information indicating 3D and information indicating a method of the image) to the encoder 202. The user data detector 2013 may output information indicating that the image is a 2D image to the encoder 202, also when the image is a 2D image.

The encoder 202 includes an image encoder 2021, and an SEI generator 2022. The image encoder 2021 encodes the decoded image into an H.264 image. The image encoder 2021 outputs the H.264 image as output image. The SEI generator 2022 generates each SEI to be included in the access unit of the H.264 image, based on the GOP structure information and the information based on the stereo video format signaling. When the information based on the stereo video format signaling is information which indicates 3D, the SEI generator 2022 records the information indicating 3D and the information indicating the method of the image in the frame packing arrangement SEI of the image. When the information based on the stereo video format signaling is information which indicates 2D, the SEI generator 2022 may records the information indicating 2D in the frame packing arrangement SEI.

According to the first embodiment, even when an MPEG-2 Video image signal is transcoded to an H.264 Video image signal, 2D/3D identification information does not disappear, but is handed over to the H.264 Video image signal. Therefore, the image recording and playback apparatus 1 can automatically display an image based on the H.264 Video image signal on the image display device 2 without user's operation, by a proper method of 2D or 3D.

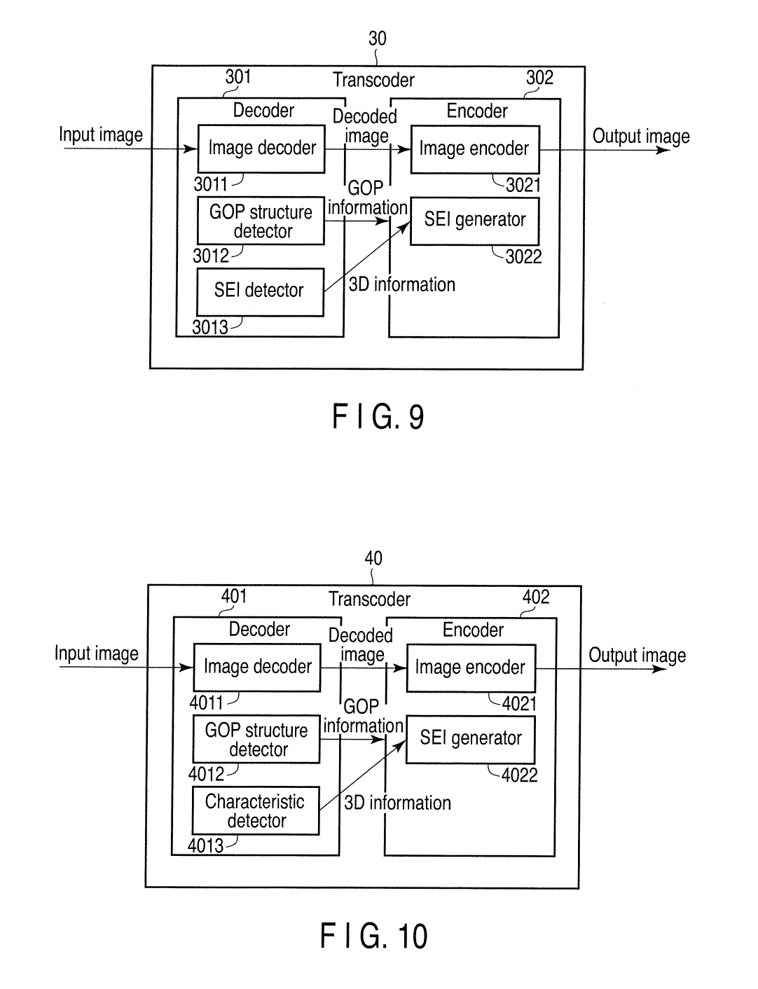

Next, a second embodiment will be explained hereinafter. FIG. 9 is a block diagram illustrating a transcoder 30 according to the second embodiment. The structure of an image recording and playback apparatus 1 of the second embodiment is the same as that of the first embodiment, and thus explanation thereof is omitted. The second embodiment is an example in which an image based on an MPEG-4 AVC (H.264 Video) (second encoding method) image signal is converted into an image based on an H.264 Video (second encoding method) image signal, and 2D/3D identification information included in the MPEG-4 AVC image signal is handed over to the H.264 Video image signal. Specifically, the second embodiment is an example of transcoding an MPEG-4 AVC image signal which is used for CS broadcasting or CATVs. MPEG-4 AVC image signals include the structure of the image stream illustrated in FIG. 8.

The transcoder 30 includes a decoder 301, and an encoder 302. The decoder 301 includes an image decoder 3011, a GOP structure detector 3012, and an SEI detector 3013. The image decoder 3011 decodes an image based on an MPEG-4 AVC image signal into an original image. The GOP structure detector 3012 detects GOP structure information from the image stream of the MPEG-4 AVC image signal. The SEI detector 3013 monitors a frame packing arrangement SEI part included in the image stream of each image of the MPEG-4 AVC image signal. The SEI detector 3013 detects whether the image is a 2D image or a 3D image, based on 2D/3D identification information which is recorded in the frame packing arrangement SEI of the image. When the image is a 3D image, the SEI detector 3013 outputs information indicating that the image is a 3D image to the encoder 302. The SEI detector 3013 may outputs information indicating that the image is a 2D image to the encoder 302, when the image is a 2D image.

The encoder 302 includes an image encoder 3021, and an SEI generator 3022. The image encoder 3021 encodes the decoded image into an H.264 Video image. The image encoder 3021 outputs the H.264 image as output image. The SEI generator 3022 records the information indicating 3D and information indicating the method of the image in the frame packing arrangement SEI of the image, in the same manner as the SEI generator 2022. When the SEI detector 3013 detects information indicating 2D, the SEI generator 3022 may record information indicating 2D in the frame packing arrangement SEI.

According to the second embodiment, even when the MPEG-4 AVC image signal is transcoded to an H.264 Video image signal, 2D/3D identification information does not disappear, but is handed over to the H.264 Video image signal.

A third embodiment will be explained hereinafter. FIG. 10 is a block diagram illustrating a transcoder 40 according to the third embodiment. The structure of an image recording and playback apparatus 1 of the second embodiment is the same as that of the first embodiment, and thus explanation thereof is omitted. The third embodiment is an example in which an image based on an MPEG-2 Video (which may be MPEG-4 AVC) image signal is identified and thereby converted into an image based on an H.264 Video image signal, and 2D/3D identification information is inserted to the H.264 Video image signal.

The transcoder 40 includes a decoder 401, and an encoder 402. The decoder 401 includes an image decoder 4011, a GOP structure detector 4012, and a characteristic detector 4013. The image decoder 4011 decodes an image based on an MPEG-2 Video image signal into an original image. The GOP structure detector 4012 detects GOP structure information from the image stream of the MPEG-2 Video image signal.

The characteristic detector 4013 monitors each image of the MPEG-2 Video image signal. The characteristic detector 4013 detects whether a left-eye image and a right-eye image which form an image are almost the same or not. When the characteristic detector 4013 detects that the left-eye image corresponds with the right-eye image with at least predetermined probability, the characteristic detector 4013 detects that the image is a 3D side-by-side image. The method of comparing the left-eye image with the right-eye image of an image by the characteristic detector 4013 is not limited. When the characteristic detector 4013 determines that the image is a 3D side-by-side image, the characteristic detector 4013 outputs information indicating that the image is a 3D side-by-side image to the encoder 402. The characteristic detector 4013 may outputs information indicating that the image is a 2D image to the encoder 402, when the image is a 2D image.

The encoder 402 includes an image encoder 4021, and an SEI generator 4022. The image encoder 4021 encodes the decoded image into an H.264 Video image. The image encoder 4021 outputs the H.264 image as output image. The SEI generator 4022 records the information indicating 3D and information indicating the method of the image in the frame packing arrangement SEI of the image, in the same manner as the SEI generator 2022. When the characteristic detector 4013 detects information indicating 2D, the SEI generator 4022 may record information indicating 2D in the frame packing arrangement SEI.

According to the third embodiment, even when stereo video format signaling is not defined in MPEG-2 Video, and even when the transcoder 40 does not include user data detector 2013 or SEI detector 3013 as in the first or second embodiment, it is possible to convert an MPEG-2 Video image signal into an H.264 Video image signal to which 2D/3D identification information is added.

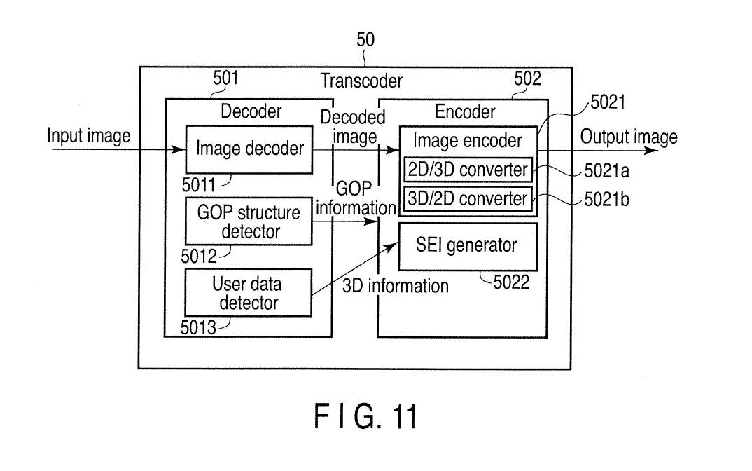

Next, a fourth embodiment will be explained hereinafter. FIG. 11 is a block diagram illustrating a transcoder 50 according to the fourth embodiment. The structure of an image recording and playback apparatus 1 of the second embodiment is the same as that of the first embodiment, and thus explanation thereof is omitted. The fourth embodiment is an example in which a 3D image is converted into a 2D image, or a 2D image is converted into a 3D image, and 2D/3D identification information is inserted into a H.264 Video image signal.

The transcoder 50 includes a decoder 501, and an encoder 502. The decoder 501 includes an image decoder 5011, a GOP structure detector 5012, and a user data detector 5013. The image decoder 5011, the GOP structure detector 5012, and the user data detector 5013 have the same structures as those of the image decoder 2011, the GOP structure detector 2012, and the user data detector 2013 of the first embodiment, respectively.

The encoder 502 includes an image encoder 5021, and an SEI generator 5022. The image encoder 5021 includes a 2D/3D converter 5021a and a 3D/2D converter 5021b. The 2D/3D converter 5021a converts a 2D image into a 3D image. The 3D/2D converter 5021b converts a 3D image into a 2D image. Specifically, the image encoder 3021 adaptively converts a decoded image into a 2D image or a 3D image, and encodes the converted image to an H.264 Video image.

For example, when the image encoder 5021 determines based on detection by the user data detector 203 that the input image is a 2D image, the image encoder 5021 determines converting the input image into a 3D image. The 2D/3D converter 5021a converts the 2D image into a pseudo 3D side-by-side image, by reducing the size of the 2D image to form a left-eye image and a right-eye image and combining the left-eye image and the right-eye image into an image. The method of converting a 2D image into a 3D image is not specifically limited.

For example, when the image encoder 5021 determines, based on detection by the user data detector 203, that the input image is a 3D image of a method which cannot be displayed by an image display device 2 being the existing equipment, the image encoder 5021 determines converting the input image into a 2D image. The 3D/2D converter 5021b converts a 3D side-by-side image into a pseudo 2D image, by enlarging the size of either of a left-eye image and a right-eye image which form the 3D image to form a full-screen 2D image. The method of converting a 3D image into a 2D image is not specifically limited.

The SEI generator 5022 records the information indicating 3D in the frame packing arrangement SEI, when the image encoder 5021 converts a 2D image into a 3D image, even when the user data detector 5013 detects information indicating 2D. The SEI generator 5022 records the information indicating 2D in the frame packing arrangement SEI, when the image encoder 5021 converts a 3D image into a 2D image, even when the user data detector 5013 detects information indicating 3D.

When the decoder 501 has a structure similar to the SEI detector 3013 instead of the user data detector 5013, the decoder 501 can detect 2D/3D identification information included in the MPEG-4 AVC image signal. Therefore, the image encoder 5021 can convert the image from 2D to 3D, or 3D to 2D, based on the 2D/3D identification information.

According to the fourth embodiment, even when the input image is a 3D image of a method which cannot be displayed by the image display device 2 of the existing equipment, the 3D image is automatically converted into a 2D image, and thereby convenience of the user who has no special equipment is improved. In addition, a 2D image is automatically converted into a pseudo 3D image, and thereby the user's convenience is improved. It is also possible to convert a 3D image of a method which cannot be displayed by the image display device 2 of the existing equipment into a 3D side-by-side image, by combining the above structures.

Although the embodiments show examples in which an image based on an MPEG-2 Video (or MPEG-4 AVC) image signal is converted into an H.264 Video image, these encoding methods are only examples. The encoding methods may be the next-generation standard such as H.265. Specifically, the embodiments are applicable to any structure which converts an image based on an image signal encoded by a first encoding method into an image encoded by a second encoding method.

The embodiments are applicable to both a 3D method of viewing images with electronic-shutter glasses, and a 3D method of viewing images with the naked eyes (without the glasses). Although the embodiments are explained with the image recording and playback apparatus 1 as an example, the embodiments are also applicable to television receivers which include an image display device 2 that displays an image based on an image signal as one unitary piece, or a set-top box. The above modules may be realized by hardware, or software by using a CPU or the like.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A signal processing apparatus comprising:
a decoder configured to decode a first image signal which is encoded by a first encoding method;
a detector configured to detect whether an image based on the first image signal is a 2D image or a 3D image;
an encoder configured to encode the first image signal into a second image signal by a second encoding method; and
a generator configured to generate information to be added to the second image signal and indicating whether an image based on the second image signal is a 2D image or a 3D image, based on detection by the detector.

2. The apparatus of claim 1, wherein the first image signal includes information indicating whether the image based on the first image signal is a 2D image or a 3D image.

3. The apparatus of claim 1, wherein the generator is configured to generate information which indicates a 3D image, when the detector detects that the image based on the first image signal is a 3D image.

4. The apparatus of claim 1, wherein the detector is configured to detect whether a left-eye image and a right-eye image based on the first image signal correspond with each other with predetermined probability or more.

5. The apparatus of claim 4, wherein the generator is configured to generate information which indicates a 3D image, when the detector detects that the left-eye image and the right-eye image correspond with each other with the predetermined probability or more.

6. The apparatus of claim 1, wherein the encoder is configured to convert the image based on the second image signal into a 3D image, when the detector detects that the image based on the first image signal is a 2D image.

7. The apparatus of claim 6, wherein the generator is configured to generate information which indicates a 3D image.

8. The apparatus of claim 1, wherein the encoder is configured to convert the image based on the second image signal into a 2D image, when the detector detects that the image based on the first image signal is a 3D image.

9. The apparatus of claim 8, wherein the encoder is configured to convert the image based on the first image signal into the image based on the second image signal by enlarging one of a right-eye image and a left-eye image based on the first image signal to a double size.

10. The apparatus of claim 8, wherein the generator is configured to generate information which indicates a 3D image.

11. The apparatus of claim 1, further comprising:
a display configured to display the image based on the second image signal.

12. A signal processing method comprising:
decoding a first image signal which is encoded by a first encoding method;
detecting whether an image based on the first image signal is a 2D image or a 3D image;
encoding the first image signal into a second image signal by a second encoding method; and
generating information to be added to the second image signal and indicating whether the image is a 2D image or a 3D image, based on the detecting.
